(19) United States
(12) Patent Application Publication
(10) Pub. No.: US 2024/0340907 A1
(43) Pub. Date: Oct. 10, 2024

(54) METHOD FOR TRANSMITTING UPLINK CONTROL INFORMATION, AND DEVICE AND CHIP

(71) Applicant: GUANGDONG OPPO MOBILE TELECOMMUNICATIONS CORP., LTD., Dongguan (CN)

(72) Inventors: Yi ZHANG, Dongguan (CN); Yanan LIN, Dongguan (CN)

(21) Appl. No.: 18/748,027

(22) Filed: Jun. 19, 2024

Related U.S. Application Data
(63) Continuation of application No. PCT/CN2022/070595, filed on Jan. 6, 2022.

(51) Int. Cl. H04W 72/21; H04W 72/11; H04W 72/56

(52) U.S. Cl. CPC H04W 72/21; H04W 72/11; H04W 72/56

(57) ABSTRACT

Provided is a method for transmitting uplink control information. The method comprises: transmitting feedback response information of a first priority, feedback response information of a second priority, and one or more scheduling requests (SRs) of the first priority over a first uplink channel resource, wherein the first priority is higher than the second priority.

### CROSS-REFERENCE TO RELATED APPLICATION

This application is a continuation of International Application No. PCT/CN2022/070595, filed Jan. 6, 2022, the entire disclosure of which is incorporated herein by reference.

### TECHNICAL FIELD

The present disclosure relates to the field of communications, and in particular, to a method and apparatus for transmitting uplink control information (UCI), a method and apparatus for receiving UCI, and a device and a storage medium.

### RELATED ARTS

In new radio (NR), for reduction of impacts of dropping a low-priority (LP) uplink channel on system efficiency, UCIs with different priorities are multiplexed on a same uplink channel for transmission. In Release 17, an LP hybrid automatic repeat request-acknowledgement (HARQ-ACK) and a high-priority (HP) HARQ-ACK are multiplexed on a same physical uplink control channel (PUCCH).

### SUMMARY

Some embodiments of the present disclosure provide a method and apparatus for transmitting UCI, a method and apparatus for receiving UCI, and a device and a storage medium, which multiplex an LP HARQ-ACK, an HP HARQ-ACK, and an HP scheduling request (SR) on a same PUCCH for transmission. The technical solutions are as follows.

According to some embodiments of the present disclosure, a method for transmitting UCI is provided.

The method includes: transmitting feedback response information of a first priority, feedback response information of a second priority, and an SR of the first priority over a first uplink channel resource, wherein the first priority is higher than the second priority.

According to some embodiments of the present disclosure, a method for receiving UCI is provided.

The method includes: receiving feedback response information of a first priority, feedback response information of a second priority, and an SR of the first priority over a first uplink channel resource, wherein the first priority is higher than the second priority.

According to some embodiments of the present disclosure, an apparatus for transmitting UCI is provided.

The apparatus includes: a transmitting module, configured to transmit feedback response information of a first priority, feedback response information of a second priority, and an SR of the first priority over a first uplink channel resource, wherein the first priority is higher than the second priority.

According to some embodiments of the present disclosure, an apparatus for receiving UCI is provided.

The apparatus includes: a receiving module, configured to receive feedback response information of a first priority, feedback response information of a second priority, and an SR of the first priority over a first uplink channel resource, wherein the first priority is higher than the second priority.

According to some embodiments of the present disclosure, a communication device is provided. The communication device includes a processor and a memory.

The memory stores one or more computer programs. The processor, when loading and running the one or more computer programs, is caused to perform the method for transmitting UCI as described above.

According to some embodiments of the present disclosure, a chip is provided. The chip includes programmable logic circuitry and/or one or more program instructions. The chip, when running, is caused to perform the method for transmitting UCI as described above.

According to some embodiments of the present disclosure, a non-transitory computer-readable storage medium is provided. The computer-readable storage medium stores one or more computer programs. The one or more computer programs, when loaded and run by a processor, cause the processor to perform the method for transmitting UCI as described above.

It should be understood that the above general description and the following detailed description are merely exemplary and explanatory, and should not constitute any limitation on the present disclosure.

### BRIEF DESCRIPTION OF DRAWINGS

For clearer descriptions of the technical solutions in the embodiments of the present disclosure, the accompanying drawings required for describing the embodiments are briefly introduced below. Apparently, the accompanying drawings in the following description show merely some embodiments of the present disclosure, and those of ordinary skill in the art may still derive other drawings from these accompanying drawings without creative efforts.

FIG. 1 is a schematic diagram of an architecture of a communication system according to some embodiments of the present disclosure;

FIG. 2 is a flowchart of a method for transmitting UCI according to some embodiments of the present disclosure;

FIG. 3 is a flowchart of a method for transmitting UCI according to some embodiments of the present disclosure;

FIG. 4 is a schematic diagram of determining a first PUCCH carrying an HP dynamic A/N, an LP A/N, and an HP SR according to some embodiments of the present disclosure;

FIG. 5 is a flowchart of a method for transmitting UCI according to some embodiments of the present disclosure;

FIG. 6 is a schematic diagram of determining a first PUCCH carrying an HP semi-persistent scheduling (SPS) A/N, an LP A/N, and an HP SR according to some embodiments of the present disclosure;

FIG. 7A is a schematic diagram showing that the uplink channel for carrying the HP SR overlaps the uplink channel for carrying the HP feedback response information according to some embodiments of the present disclosure;

FIG. 7B is a schematic diagram showing that the uplink channel for carrying the HP SR overlaps the uplink channel for carrying the LP feedback response information according to some embodiments of the present disclosure;

FIG. 7C is a schematic diagram showing that the uplink channel for carrying the HP SR overlaps both the uplink channel for carrying the HP feedback response information and the uplink channel for carrying the LP feedback response information according to some embodiments of the present disclosure;

FIG. 7D is a schematic diagram showing that the terminal device multiplexes K=4 HP SRs according to some embodiments of the present disclosure;

FIG. 8 is a flowchart of a method for receiving UCI according to some embodiments of the present disclosure;

FIG. 9 is a flowchart of a method for receiving UCI according to some embodiments of the present disclosure;

FIG. 10 is a flowchart of a method for receiving UCI according to some embodiments of the present disclosure;

FIG. 11 is a structural block diagram of an apparatus for transmitting UCI according to some embodiments of the present disclosure;

FIG. 12 is a structural block diagram of an apparatus for receiving UCI according to some embodiments of the present disclosure; and

FIG. 13 is a schematic structural diagram of a communication device according to some embodiments of the present disclosure.

### DETAILED DESCRIPTION

Exemplary embodiments are described hereinafter in detail, examples of which are represented in the accompanying drawings. When the following descriptions relate to the accompanying drawings, unless otherwise stated, same numerals in different accompanying drawings represent same or similar elements. Implementations described in the following exemplary embodiments do not represent all implementations consistent with the present disclosure. On the contrary, the implementations are merely examples of apparatuses and methods that are described in detail in the appended claims and consistent with some aspects of the present disclosure.

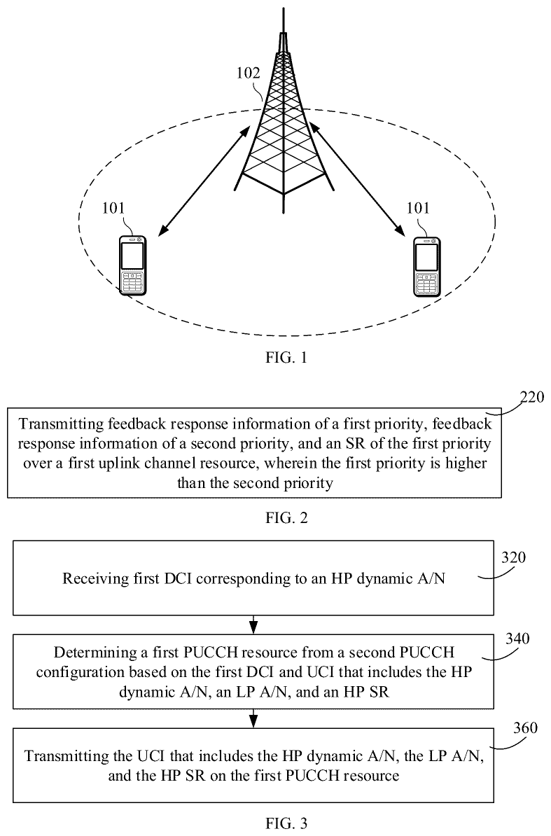

FIG. 1 is a schematic diagram of an architecture of a communication system according to some embodiments of the present disclosure. As shown in FIG. 1, the communication system may include a network device 102. The network device 102 may be a device that communicates with a terminal device 101 (or referred to as a communication terminal or a terminal). The network device 102 may provide communication coverage for a specific geographical area and communicate with terminal devices within the coverage.

FIG. 1 exemplarily shows one network device 102 and two terminal devices 101. In some embodiments of the present disclosure, the communication system may include a plurality of network devices 102, and each network device 102 may cover another number of terminal devices 101, which is not limited in the embodiments of the present disclosure.

In the embodiments of the present disclosure, the terminal device 101 may be a station in a wireless local area network (WLAN); or may be a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal device 101 in a next-generation communication system such as an NR network, a terminal device 101 in an evolved public land mobile network (PLMN), or the like.

In the embodiments of the present disclosure, the terminal device 101 may be a device that provides voice and/or data connectivity to a user, and may be configured to be connected to a person, an object, and a machine, for example, a handheld device or vehicle-mounted device with a wireless connection function. The terminal device 101 in the embodiments of the present disclosure may be a mobile phone, a tablet computer (or referred to as a pad), a laptop computer, a palmtop computer, a mobile Internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, or the like. Optionally, a UE may be configured to act as a base station. For example, the terminal device 101 may act as a scheduling entity that provides a sidelink signal between terminal devices 101 in vehicle-to-everything (V2X), device-to-device (D2D), or the like. For example, a cellular phone and a vehicle communicate with each other over a sidelink signal. A cellular phone and a smart home device communicate with each other without relaying a communication signal over a base station.

In the embodiments of the present disclosure, the terminal device 101 may be deployed on land, including indoor or outdoor, handheld, wearable, or vehicle-mounted; may be deployed on water (such as a ship); or may be deployed in the air (such as on an aircraft, a balloon, or a satellite).

The terminal device 101 in the embodiments of the present disclosure may also be referred to as a terminal, a UE, an access terminal device, a vehicle-mounted terminal, an industrial control terminal, a UE unit, a UE station, a mobile station, a mobile, a remote station, a remote terminal device, a mobile device, a UE terminal device, a wireless communication device, a UE proxy, a UE apparatus, or the like. The terminal device 101 may be stationary or mobile.

By way of example but not limitation, in the embodiments of the present disclosure, the terminal device 101 may alternatively be a wearable device. The wearable device may also be referred to as a wearable intelligent device, is a generic name of the wearable devices, such as glasses, gloves, watches, clothing, or shoes, which are intelligently designed and developed for daily wear by using wearable technologies. The wearable device is a portable device that is directly worn or integrated into a user's clothing or accessory. The wearable device is not only a hardware device, but also implements powerful functions by software support, data interaction, and cloud interaction. The wearable intelligent devices in a broad sense include devices such as smart watches or smart glasses which have full functionality and large size and are capable of implementing all or part of functionality without relying on smart phones, devices such as smart watches or smart glasses, and devices such as various smart bands or smart jewelries used for monitoring physical signs, which are dedicated to a specific type of application functions and need to be used in cooperation with other devices such as smart phones.

The network device 102 in the embodiments of the present disclosure may be a device configured to communicate with the terminal device 101. The network device 102 may also be referred to as an access network device or a radio access network (RAN) device. For example, the network device 102 may be a base station. The network device 102 in the embodiments of the present disclosure may be a RAN node (or device) that connects the terminal device 101 to a wireless network. The base station may broadly cover or be replaced with various devices as follows: a node B (NodeB), an evolved NodeB (eNB), a next generation NodeB (gNB), a relay station, an access point, a transmitting and receiving point (TRP), a transmitting point (TP), a master eNB (MeNB), a secondary eNB (SeNB), a multi-standard radio (MSR) node, a home base station, a network controller, an access node, a radio node, an access point (AP), a transmitting node, a transmitting and receiving node, a base band unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. The base station may alternatively be a communication module, a modem, or a chip disposed in the foregoing device or apparatus. The base station may alternatively be a mobile switching center, a device that functions as the base station in D2D, V2X, or machine-to-machine (M2M) communications, a network-side device in a 6G network, a device that functions as the base station in a future communication system, or the like. The base station may support networks with the same or different access technologies. A specific technology and specific device form used by the network device 102 are not limited in the embodiments of the present disclosure.

The base station may be stationary or mobile. For example, a helicopter or an unmanned aerial vehicle (UAV) may be configured to act as a mobile base station. One or more cells may move based on a location of the mobile base station. In another example, the helicopter or the UAV may be configured as a device that communicates with another base station.

In some deployments, the network device 102 in the embodiments of the present disclosure may be a CU or a DU, or the network device 102 may include a CU and a DU. The gNB may further include an AAU.

The network device 102 and the terminal device 101 may be deployed on land, including indoors or outdoors, handheld, or vehicle-mounted; may be deployed on water; or may be deployed on an aircraft, a balloon, or a satellite in the air. The scenario where the network device 102 and the terminal device 101 are used is not limited in the embodiments of the present disclosure.

By way of example but not limitation, in the embodiments of the present disclosure, the network device 102 may have mobility capabilities. For example, the network device 102 may be a mobile device. In some embodiments of the present disclosure, the network device 102 may be a satellite or a balloon station. For example, the satellite may be a low Earth orbit (LEO) satellite, a medium Earth orbit (MEO) satellite, a geostationary Earth orbit (GEO) satellite, a high elliptical orbit (HEO) satellite, or the like. In some embodiments of the present disclosure, the network device 102 may alternatively be a base station deployed on land, water, or the like.

In the embodiments of the present disclosure, the network device 102 may provide services for a cell. The terminal device 101 communicates with the network device 102 over transmission resources (for example, frequency domain resources or spectrum resources) used by the cell. The cell may be a cell corresponding to the network device 102 (for example, a base station). The cell may belong to a macro base station or a base station corresponding to a small cell. The small cell may include a metro cell, a micro cell, a pico cell, a femto cell, or the like. The small cell features small coverage and low transmission power, and is applicable to providing high-rate data transmission services.

Some terms in the present disclosure are described hereinafter.

SPS: SPS is used to reduce physical downlink control channel (PDCCH) overheads. A network device transmits activation downlink control information (DCI) once to schedule a plurality of downlink transmissions that occur periodically. Its implementation mechanism is as follows: The network device configures an SPS periodicity, a HARQ process, and the like for a terminal device over radio resource control (RRC) signaling, performs activation/deactivation through DCI scrambled by using a configured scheduling-radio network temporary identifier (CS-RNTI), and indicates a time-frequency resource occupied by an SPS PDSCH, a modulation and coding scheme (MCS) used, PDSCH to HARQ-ACK feedback timing, and the like in activation DCI.

In the related art, only one activated SPS configuration is supported in each bandwidth part (BWP) of each cell. A HARQ-ACK feedback resource corresponding to an SPS PDSCH in each periodicity is configured over an RRC parameter n1PUCCH-AN. In the case that the SPS periodicity is at least 10 ms, a periodicity of a semi-static uplink-downlink configuration is well matched. That is, each PUCCH resource carrying an SPS HARQ-ACK contains only a 1-bit HARQ-ACK. Therefore, the PUCCH resource configured over n1PUCCH-AN is the PUCCH format 0/1 (the PUCCH format 0/1 carries only 1 bit or 2 bits of information).

In a URLLC/Industrial Internet of Things (IIoT) project, to make SPS better adapt to an IIoT service, a plurality of SPS configurations simultaneously activated are supported in one BWP. A plurality of parameters related to SPS are configured over RRC respectively. That is, HARQ-ACK information corresponding to SPS PDSCHs of the plurality of SPS configurations may be fed back over a same PUCCH. Therefore, the PUCCH resource of the PUCCH format 0/1 configured over n1PUCCH-AN fails to meet the requirement. Further, the network device is capable of configuring up to 4 PUCCH resources for the terminal device over an RRC parameter SPS-PUCCH-AN-List. Different PUCCH resources correspond to different ranges of a HARQ-ACK payload size (for example, a first PUCCH resource is selected in the case that the HARQ-ACK payload size ranges from N_{0,min} to N_{0,max}, and a second PUCCH resource is selected in the case that the HARQ-ACK payload size ranges from N_{1,min} to N_{1,max}). A plurality of PUCCH resources are applicable to all SPS configurations.

SR: In the case that uplink data needs to be transmitted, a terminal device transmits an SR to a network device to request an uplink transmission resource from the network device. A resource for transmitting the SR is configured by the network device over RRC signaling. The network device may configure a plurality of SR configurations corresponding to different logical channels for the terminal device. The resource for transmitting the SR configured by the network device is a PUCCH format 0 or PUCCH format 1, that is, the resource carries 1 bit or 2 bits of information.

Intra-UE prioritization for URLLC:

In the related art of NR, to better support URLLC services, a high priority (HP) and a low priority (LP) are introduced into a physical layer for uplink channels. A priority index 0 indicates the LP. A priority index 1 indicates the HP. In an NR R16 system, in the case that uplink channels with different priorities overlap in time domain, only an HP channel is transmitted and an LP channel is dropped. In other words, transmission of the HP channel is preferentially ensured. HP control information and LP control information correspond to different PUCCH configurations (PUCCH-Configs). For example, in the case that a terminal is configured with two PUCCH configurations, a priority index corresponding to the first PUCCH configuration is 0 and a priority index corresponding to the second PUCCH configuration is 1. Content corresponding to the HP and LP control information may be separately configured.

A method for determining a PUCCH resource used by (HP/LP) HARQ-ACK information corresponding to a dynamically scheduled PDSCH (hereinafter referred to as a dynamic A/N) is as follows: One of a plurality of PUCCH resource sets in a corresponding PUCCH configuration is determined based on a total number of bits of the HARQ-ACK information. Then, a PUCCH resource in the PUCCH resource set is determined based on a PUCCH resource indicator field in DCI. A PUCCH resource used by (HP/LP) HARQ-ACK information corresponding to an SPS PDSCH (hereinafter referred to as an SPS A/N) is determined based on sps-PUCCH-AN-List-r16 configured in a PUCCH configuration. Similarly, a resource of an SR is also configured in a PUCCH configuration.

Intra-UE multiplexing for URLLC

Further, for reduction of impact of dropping an LP uplink channel on system efficiency, overlapping channels with different priorities are multiplexed for transmission. In some embodiments, the following multiplexing of uplink channels is supported:

multiplexing of an LP HARQ-ACK and an HP HARQ-ACK on a same PUCCH;

multiplexing of an LP HARQ-ACK and an HP SR on a same PUCCH (for a specific HARQ-ACK/SR PUCCH format combination); and

multiplexing of an LP HARQ-ACK, an HP HARQ-ACK, and an HP SR on a same PUCCH.

For multiplexing of the LP HARQ-ACK and the HP HARQ-ACK on the same PUCCH, in Release 17, regardless of a total number of bits of the LP HARQ-ACK and the HP HARQ-ACK, a PUCCH resource of the HP HARQ-ACK included in an HP PUCCH configuration carries the LP HARQ-ACK and the HP HARQ-ACK. In the case that the total number of bits of the HP HARQ-ACK and the LP HARQ-ACK is greater than 2, separate coding is supported for the HP HARQ-ACK and the LP HARQ-ACK. A rate matching equation and a resource element (RE) mapping rule of A/N+CSI-1 in Release 15 are reused for an HP A/N. A rate matching equation and an RE mapping rule of CSI-2 in Release 15 are reused for an LP A/N. In the case that the total number of bits of the HP HARQ-ACK and the LP HARQ-ACK is 2, (HP+LP) HARQ-ACK information of 2 bits is regarded as HP HARQ-ACK information of 2 bits.

Apparently, during standardization of intra-UE multiplexing for URLLC, a solution (such as transmission resource selection or an RE mapping rule) of multiplexing the HP HARQ-ACK and the LP HARQ-ACK on the same PUCCH for transmission is standardized. However, a solution of multiplexing the LP A/N, the HP A/N, and the HP SR on the same PUCCH for transmission have not been discussed. Therefore, the present disclosure mainly focuses on the solution to multiplexing the LP A/N, the HP A/N, and the HP SR on the same PUCCH for transmission.

In the present disclosure, the LP A/N is equivalent to the LP HARQ-ACK, and the HP A/N is equivalent to the HP HARQ-ACK.

The technical solutions according to the present disclosure are described hereinafter through several embodiments.

FIG. 2 is a flowchart of a method for transmitting UCI according to some embodiments of the present disclosure. Description is given in the embodiments based on an example in which the method is applicable to a terminal device. The method includes the following processes.

In process 220, feedback response information of a first priority, feedback response information of a second priority, and an SR of the first priority are transmitted over a first uplink channel resource. The first priority is higher than the second priority.

In some embodiments, the first uplink channel resource includes a first PUCCH resource.

In some embodiments, the feedback response information of the first priority includes an HP HARQ-ACK/negative ACK (NACK) (HP A/N for short). The feedback response information of the second priority includes an LP HARQ-ACK/NACK (LP A/N for short). The SR of the first priority includes an HP SR.

In some embodiments, the first priority includes a priority index 1, which may also be referred to as an HP. In some embodiments, the second priority includes a priority index 0, which may also be referred to as an LP.

In some embodiments, the feedback response information of the first priority includes feedback response information of the first priority for dynamic scheduling (an HP dynamic A/N for short) and feedback response information of the first priority for SPS (an HP SPS A/N for short), which will be described in detail in the following embodiments.

In some embodiments, an uplink channel for carrying the feedback response information of the first priority, an uplink channel for carrying the feedback response information of the second priority, and an uplink channel for carrying the SR of the first priority overlap.

In some embodiments, the uplink channel for carrying the feedback response information of the first priority, the uplink channel for carrying the feedback response information of the second priority, and the uplink channel for carrying the SR of the first priority overlap and satisfy a multiplexing timeline. In the case that the multiplexing timeline is satisfied, the terminal device multiplexes the uplink channel for carrying the feedback response information of the first priority, the uplink channel for carrying the feedback response information of the second priority, and the uplink channel for carrying the SR of the first priority.

In some embodiments, in the case that the multiplexing timeline is satisfied, the terminal device multiplexes the feedback response information of the first priority, the feedback response information of the second priority, and the SR of the first priority to obtain UCI. The terminal device transmits the UCI over the first uplink channel resource.

In some embodiments, satisfying the multiplexing timeline means that a terminal has capabilities to process multiplexing between the three uplink channels prior to the first PUCCH resource.

In some embodiments, that the uplink channel for carrying the feedback response information of the first priority, the uplink channel for carrying the feedback response information of the second priority, and the uplink channel for carrying the SR of the first priority overlap includes: the uplink channel for carrying the feedback response information of the first priority, the uplink channel for carrying the feedback response information of the second priority, and the uplink channel for carrying the SR of the first priority overlap in time domain.

In some embodiments, that the uplink channel for carrying the feedback response information of the first priority, the uplink channel for carrying the feedback response information of the second priority, and the uplink channel for carrying the SR of the first priority overlap includes: the uplink channel for carrying the SR of the first priority partially or completely overlaps only the uplink channel for carrying the feedback response information of the first priority; the uplink channel for carrying the SR of the first priority partially or completely overlaps only the uplink channel for carrying the feedback response information of the second priority; or the uplink channel for carrying the SR of the first priority partially or completely overlaps the uplink channel for carrying the feedback response information of the first priority and the uplink channel for carrying the feedback response information of the second priority.

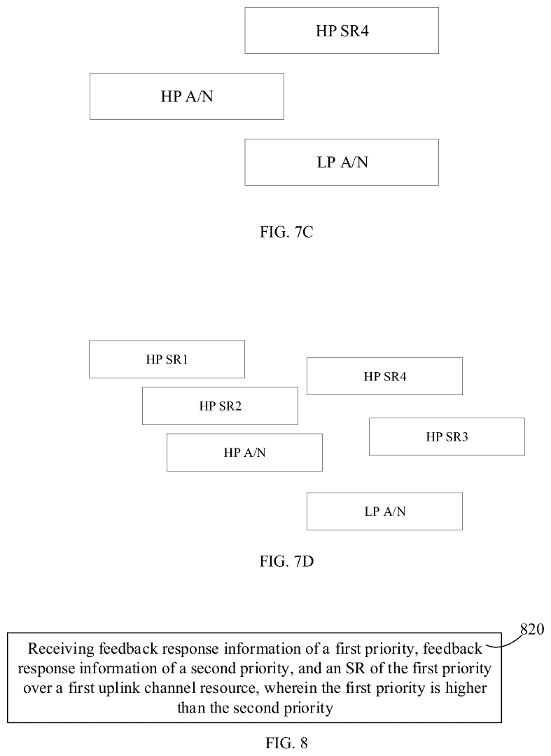

In some embodiments, for details of overlapping between a channel carrying the HP SR, a channel carrying the HP dynamic A/N, and a channel carrying the LP A/N, refer to the following embodiments shown in FIGS. 7A to 7D.

In some embodiments, the first PUCCH resource is a PUCCH resource configured in a PUCCH configuration corresponding to the first priority. In other words, the first PUCCH resource is determined based on the PUCCH configuration corresponding to the first priority. In some embodiments, the PUCCH configuration corresponding to the first priority includes a second PUCCH configuration, and a PUCCH configuration corresponding to the second priority includes a first PUCCH configuration.

In summary, the feedback response information of the first priority, the feedback response information of the second priority, and the SR of the first priority are transmitted over the first PUCCH resource. The first priority is higher than the second priority. In this way, a technical problem of multiplexing an LP A/N, an HP A/N, and an HP SR on a same PUCCH for transmission is solved.

The following describes in detail two scenarios for the feedback response information of the first priority for dynamic scheduling (HP dynamic A/N for short) and the feedback response information of the first priority for SPS (HP SPS A/N for short).

Scenario for the HP dynamic A/N:

In some embodiments, the first uplink channel resource is a PUCCH resource in a PUCCH resource set. The PUCCH resource set belongs to the PUCCH configuration corresponding to the first priority. In other words, the PUCCH resource set is determined based on the PUCCH configuration corresponding to the first priority.

FIG. 3 is a flowchart of a method for transmitting UCI according to some embodiments of the present disclosure. Description is given in the embodiments based on an example in which the method is applicable to a terminal device. The method includes the following processes.

In process 320, first DCI corresponding to an HP dynamic A/N is received.

In some embodiments, the first DCI is DCI corresponding to feedback response information of a first priority for dynamic scheduling. The terminal device receives the first DCI from a network device.

In some embodiments, the HP dynamic A/N is HARQ-ACK information of a PDSCH for dynamic scheduling. That is, the first DCI schedules the HARQ-ACK information and/or the PDSCH.

In some embodiments, the first DCI includes a PUCCH resource indicator field. In some embodiments, receiving the first DCI corresponding to the HP dynamic A/N may be replaced by receiving a PUCCH resource indicator field corresponding to the HP dynamic A/N.

In process 340, a first PUCCH resource is determined from a second PUCCH configuration based on the first DCI and UCI that includes the HP dynamic A/N, an LP A/N, and an HP SR.

In some embodiments, based on a total number of bits of the UCI that includes the HP dynamic A/N, the LP A/N, and the HP SR, the terminal device determines to use a PUCCH resource set in the second PUCCH configuration.

In some embodiments, the terminal device determines a PUCCH resource in the PUCCH resource set as the first PUCCH resource based on the PUCCH resource indicator field included in the first DCI.

In some embodiments, the terminal device adds K HP SRs to the HP dynamic A/N to form HP UCI. K is a positive integer. In some embodiments, adding may be understood as adding the HP SRs before or after the HP dynamic A/N.

In some embodiments, in the case that the number of HP SRs is K, the HP SRs are added to the HP dynamic A/N to form HP UCI with O_{UCI-HP} bits.

In some embodiments, O_{UCI-HP}=O_{HP-ACK}+[log₂(K+1)]. O_{UCI-HP} represents the number of bits of the HP UCI. O_{HP-ACK} represents the number of bits of the HP dynamic A/N. [log₂(K+1)] is used to calculate the number of bits of the K HP SRs. log₂(K+1) is used to calculate a logarithm of (K+1) to the base 2. ┌ ┐ represents rounding up log₂(K+1). K is a positive integer.

In some embodiments, an uplink channel for carrying the HP dynamic A/N, an uplink channel for carrying the LP A/N, and an uplink channel for carrying the HP SR overlap.

In some embodiments, the uplink channel for carrying the HP dynamic A/N, the uplink channel for carrying the LP A/N, and the uplink channel for carrying the HP SR overlap and satisfy a multiplexing timeline. In the case that the multiplexing timeline is satisfied, the terminal device multiplexes the uplink channel for carrying the HP dynamic A/N, the uplink channel for carrying the LP A/N, and the uplink channel for carrying the HP SR.

In some embodiments, satisfying the multiplexing timeline means that a terminal has capabilities to process multiplexing between the three uplink channels prior to the first PUCCH resource.

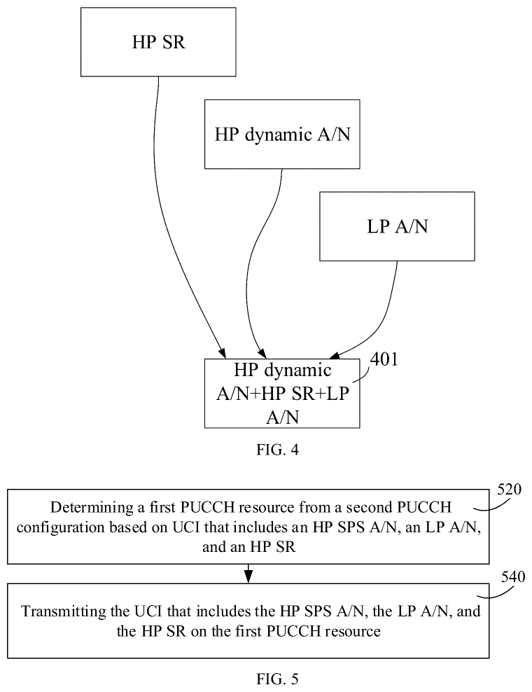

In some embodiments, FIG. 4 is a schematic diagram showing that the terminal determines a first PUCCH carrying the HP dynamic A/N, the LP A/N, and the HP SR. FIG. 4 shows that the channel carrying the HP SR, the channel carrying the HP dynamic A/N, and the channel carrying the LP A/N overlap. The terminal device multiplexes the HP SR, the HP dynamic A/N, and the LP A/N on the first PUCCH 401 for transmission.

In some embodiments, the number of SRs of the first priority is K. K is a positive integer. The K SRs of the first priority include a target SR.

In some embodiments, an uplink channel for carrying the target SR overlaps the uplink channel for carrying the HP A/N.

In some embodiments, an uplink channel for carrying the target SR overlaps the uplink channel for carrying the LP A/N.

In some embodiments, an uplink channel for carrying the target SR overlaps both the uplink channel for carrying the feedback response information of the first priority and the uplink channel for carrying the feedback response information of the second priority.

In some embodiments, for details of overlapping between the channel carrying the target SR, the channel carrying the HP dynamic A/N, and the channel carrying the LP A/N, reference is made to the following embodiments shown in FIGS. 7A to 7D.

In process 360, the UCI that includes the HP dynamic A/N, the LP A/N, and the HP SR is transmitted over the first PUCCH resource.

In some embodiments, the terminal device transmits the UCI that includes the HP dynamic A/N, the LP A/N, and the HP SR on the first PUCCH resource.

In summary, in the case that the LP A/N, the HP A/N, and the HP SR are multiplexed and transmitted over the same PUCCH, multiplexed information is transmitted over a resource of the HP dynamic A/N, which ensures low latency and high reliability of HP information. In the case that a resource of the HP SR is used for transmission, according to the description of the related art, the HP SR carries up to 2 bits and fails to carry three types of UCI. In the case that a resource of the LP A/N is used for transmission, a code rate, a symbol length, and the like of an LP PUCCH may not meet latency and reliability requirements of the HP A/N.

Scenario for the HP SPS A/N:

In some embodiments, the first uplink channel resource is a PUCCH resource in a PUCCH feedback resource list corresponding to SPS. In some embodiments, the PUCCH feedback resource list belongs to the PUCCH configuration corresponding to the first priority.

In some embodiments, the first uplink channel resource is determined based on a first total number of bits and PUCCH resources in the PUCCH feedback resource list corresponding to SPS. In some embodiments, the first total number of bits is a sum of the number of bits of the feedback response information of the first priority, the number of bits of the feedback response information of the second priority, and the number of bits of the SR of the first priority.

FIG. 5 is a flowchart of a method for transmitting UCI according to some embodiments of the present disclosure. Description is given in the embodiments based on an example in which the method is applicable to a terminal device. The method includes the following processes.

In process 520, a first PUCCH resource is determined from a second PUCCH configuration based on UCI that includes an HP SPS A/N, an LP A/N, and an HP SR.

In some embodiments, based on a total number of bits of the UCI that includes the HP SPS A/N, the LP A/N, and the HP SR, the terminal device determines to use a PUCCH resource corresponding to the total number of bits in a PUCCH feedback resource list in the second PUCCH configuration as the first PUCCH resource.

In some embodiments, based on a total number of bits of the UCI that includes the HP SPS A/N, the LP A/N, and the HP SR, the terminal device determines to use a PUCCH resource within a range corresponding to the total number of bits in a PUCCH feedback resource list in the second PUCCH configuration as the first PUCCH resource.

In some embodiments, based on a total number of bits of the UCI that includes the HP SPS A/N, the LP A/N, and the HP SR, the terminal device determines to use one of a plurality of PUCCH resources within a range corresponding to the total number of bits in a PUCCH feedback resource list in the second PUCCH configuration as the first PUCCH resource.

In some embodiments, the PUCCH feedback resource list corresponds to an SPS PDSCH. In some embodiments, a PUCCH feedback resource list corresponding to the SPS PDSCH includes SPS-PUCCH-AN-List and/or n1PUCCH-AN.

In some embodiments, the terminal device adds K HP SRs to the HP SPS A/N to form HP UCI.

In some embodiments, in the case that the number of HP SRs is K, the HP SRs are added to the HP SPS A/N to form HP UCI with O_{UCI-HP} bits.

In some embodiments, O_{UCI-HP}=O_{HP-ACK}+[log₂(K+1)]. O_{UCI-HP} represents the number of bits of the HP UCI. O_{HP-ACK} represents the number of bits of the HP SPS A/N. [log₂(K+1)] represents the number of bits of the K HP SRs. K is a positive integer. log₂(K+1) is used to calculate a logarithm of (K+1) to the base 2. ┌ ┐ represents rounding up log₂(K+1).

In some embodiments, the SPS A/N includes HARQ-ACK feedback information for the SPS PDSCH. In some embodiments, the SPS PDSCH includes a PDSCH without corresponding PDCCH/DCI.

In some embodiments, an uplink channel for carrying the HP SPS A/N, an uplink channel for carrying the LP A/N, and an uplink channel for carrying the HP SR overlap.

In some embodiments, the uplink channel for carrying the HP SPS A/N, the uplink channel for carrying the LP A/N, and the uplink channel for carrying the HP SR overlap and satisfy a multiplexing timeline. In the case that the multiplexing timeline is satisfied, the terminal device multiplexes the uplink channel for carrying the HP SPS A/N, the uplink channel for carrying the LP A/N, and the uplink channel for carrying the HP SR.

In some embodiments, satisfying the multiplexing timeline means that a terminal has capabilities to process multiplexing between the three uplink channels prior to the first PUCCH resource.

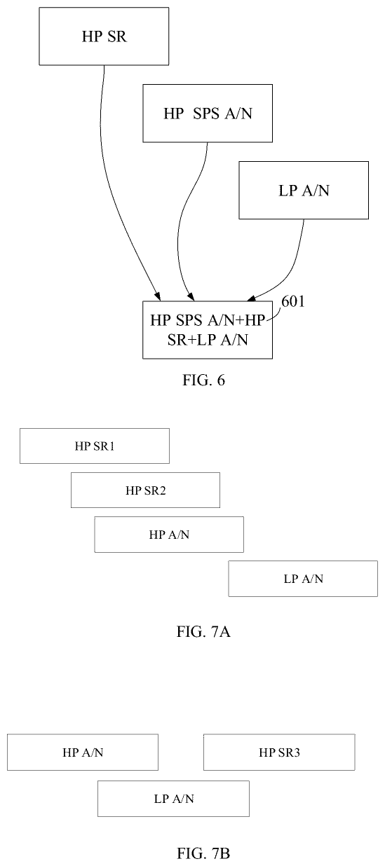

In some embodiments, FIG. 6 is a schematic diagram showing that the terminal device determines a first PUCCH carrying the HP SPS A/N, the LP A/N, and the HP SR. FIG. 6 shows that the channel carrying the HP SR, the channel carrying the HP SPS A/N, and the uplink channel carrying the LP A/N overlap. The terminal device multiplexes the HP SR, the HP SPS A/N, and the LP A/N on the first PUCCH 601 for transmission.

In some embodiments, the number of SRs of the first priority is K. K is a positive integer. The K SRs of the first priority include a target SR.

In some embodiments, an uplink channel for carrying the target SR overlaps the uplink channel for carrying the HP A/N.

In some embodiments, an uplink channel for carrying the target SR overlaps the uplink channel for carrying the LP A/N.

In some embodiments, an uplink channel for carrying the target SR overlaps both the uplink channel for carrying the feedback response information of the first priority and the uplink channel for carrying the feedback response information of the second priority.

In some embodiments, for details of overlapping between the channel carrying the target SR, the channel carrying the HP dynamic A/N, and the channel carrying the LP A/N, reference is made to the following embodiments shown in FIGS. 7A to 7D.

In process 540, the UCI that includes the HP SPS A/N, the LP A/N, and the HP SR is transmitted over the first PUCCH resource.

In some embodiments, the terminal device transmits the UCI that includes the HP SPS A/N, the LP A/N, and the HP SR on the first PUCCH resource.

In summary, in the case that the LP A/N, the HP A/N, and the HP SR are multiplexed and transmitted over the same PUCCH, multiplexed information is transmitted over a resource of the HP SPS A/N, which ensures low latency and high reliability of HP information. In the case that a resource of the HP SR is used for transmission, according to the description of the related art, the HP SR carries up to 2 bits and fails to carry three types of UCI. In the case that a resource of the LP A/N is used for transmission, a code rate, a symbol length, and the like of an LP PUCCH may not meet latency and reliability requirements of the HP A/N.

In some embodiments, the terminal device does not expect a first total number of bits to be greater than a maximum number of bits carried by the PUCCH feedback resource list for SPS. The first total number of bits is a sum of the number of bits of the feedback response information of the first priority, the number of bits of the feedback response information of the second priority, and the number of bits of the SR of the first priority.

It should be noted that the process that the terminal device does not expect the first total number of bits to be greater than the maximum number of bits carried by the PUCCH feedback resource list for SPS includes: in the case that the feedback response information of the first priority, the feedback response information of the second priority, and the SR of the first priority are transmitted over the first PUCCH resource, not expecting, by the terminal device, the first total number of bits to be greater than the maximum number of bits carried by the PUCCH feedback resource list for SPS; and in the case that the feedback response information of the first priority, the feedback response information of the second priority, and the SR of the first priority are not transmitted over the first PUCCH resource, not expecting, by the terminal device, the first total number of bits to be greater than the maximum number of bits carried by the PUCCH feedback resource list for SPS.

In some embodiments, a network device estimates a second total number of bits. The second total number of bits is the sum of the number of bits of the feedback response information of the first priority, the number of bits of the feedback response information of the second priority, and the number of bits of the SR of the first priority. The network device configures the maximum number of bits carried by the PUCCH feedback resource list for SPS to be greater than the second total number of bits.

It should be noted that the process that network device configures the maximum number of bits carried by the PUCCH feedback resource list for SPS to be greater than the second total number of bits includes: in the case that the feedback response information of the first priority, the feedback response information of the second priority, and the SR of the first priority are transmitted over the first PUCCH resource, configuring, by the network device, the maximum number of bits carried by the PUCCH feedback resource list for SPS to be greater than the second total number of bits; and in the case that the feedback response information of the first priority, the feedback response information of the second priority, and the SR of the first priority are not transmitted over the first PUCCH resource, configuring, by the network device, the maximum number of bits carried by the PUCCH feedback resource list for SPS to be greater than the second total number of bits.

In some embodiments, the method for transmitting UCI in the embodiments of the present disclosure further includes: the terminal device receives a PUCCH configuration from the network device.

In some embodiments, the process that the terminal device receives the PUCCH configuration from the network device includes: receiving, by the terminal device, a first PUCCH configuration and a second PUCCH configuration from the network device. The first PUCCH configuration corresponds to the LP A/N. That is, a priority index corresponding to the first PUCCH configuration is 0. The second PUCCH configuration corresponds to the HP A/N. That is, a priority index corresponding to the second PUCCH configuration is 1. In some embodiments, an uplink channel for feedback response information is configured based on the PUCCH configuration. In some embodiments, a PUCCH resource corresponding to the HP A/N is configured based on the first PUCCH configuration, and a PUCCH resource corresponding to the LP A/N is configured based on the second PUCCH configuration.

In some embodiments, transmitting the feedback response information of the first priority, the feedback response information of the second priority, and the SR of the first priority on the first PUCCH resource may be replaced by transmitting the feedback response information of the first priority, the feedback response information of the second priority, and channel state information (CSI) on the first PUCCH resource.

Based on the optional embodiments shown in FIG. 3 and FIG. 5, that the uplink channel for carrying HP feedback response information (the HP A/N, including the HP dynamic A/N and the HP SPS A/N), the uplink channel for carrying LP feedback response information, and the uplink channel for carrying the HP SR overlap includes at least one of the following three cases.
Case 1: The uplink channel for carrying the HP SR overlaps the uplink channel for carrying the HP feedback response information.

In some embodiments, the uplink channel for carrying the HP SR overlaps the uplink channel for carrying the HP feedback response information in time domain.

In some embodiments, the uplink channel for carrying the HP SR partially or completely overlaps the uplink channel for carrying the HP feedback response information.

In some embodiments, partial overlapping may be understood as that the uplink channel for carrying the HP SR completely belongs to the uplink channel for carrying the HP feedback response information; or that the uplink channel for carrying the HP SR intersects with the uplink channel for carrying the HP feedback response information.

In some embodiments, FIG. 7A is a schematic diagram showing that the uplink channel for carrying the HP SR overlaps the uplink channel for carrying the HP feedback response information according to some embodiments of the present disclosure. In this case, the terminal device multiplexes K=2 HP SRs.

In some embodiments, the uplink channel for carrying the HP feedback response information includes an uplink channel for the HP feedback response information on which HP UCI is not multiplexed, and/or an uplink channel on which the HP feedback response information and the HP SR are multiplexed.

In some embodiments, the terminal device determines that an uplink channel (for example, a second PUCCH resource) on which the HP feedback response information and an HP SRI are multiplexed overlaps an uplink channel for carrying an HP SR2. The terminal device determines an uplink channel (for example, the first PUCCH resource) on which the HP feedback response information, the HP SR1, and the HP SR2 are multiplexed. In some embodiments, the HP SR includes a positive SR and a negative SR; or a positive SR.

Referring to FIG. 7A, the HP SR1 includes a positive SR and the HP SR2 includes a negative SR. In this case, the K HP SRs multiplexed by the terminal device include only the HP SR1, namely the positive SR overlapping the HP feedback response information.
Case 2: The uplink channel for carrying the HP SR overlaps the uplink channel for carrying the LP feedback response information.

In some embodiments, the uplink channel for carrying the HP SR overlaps the uplink channel for carrying the LP feedback response information in time domain.

In some embodiments, the uplink channel for carrying the HP SR partially or completely overlaps the uplink channel for carrying the LP feedback response information.

In some embodiments, partial overlapping may be understood as that the uplink channel for carrying the HP SR completely belongs to the uplink channel for carrying the LP feedback response information; or that the uplink channel for carrying the HP SR intersects with the uplink channel for carrying the LP feedback response information.

In some embodiments, FIG. 7B is a schematic diagram showing that the uplink channel for carrying the HP SR overlaps the uplink channel for carrying the LP feedback response information according to some embodiments of the present disclosure. In this case, the K=1 HP SR multiplexed by the terminal device includes only an HP SR3.

In some embodiments, the uplink channel for carrying the LP feedback response information includes an uplink channel for the LP feedback response information on which LP UCI is not multiplexed, and/or an uplink channel on which the LP feedback response information and another LP uplink channel are multiplexed.

In some embodiments, the another LP uplink channel includes an uplink channel of an LP SR, an LP physical uplink shared channel (PUSCH), or the like.
Case 3: The uplink channel for carrying the HP SR overlaps both the uplink channel for carrying the HP feedback response information and the uplink channel for carrying the LP feedback response information.

In some embodiments, the uplink channel for carrying the HP SR overlaps both the uplink channel for carrying the HP feedback response information and the uplink channel for carrying the LP feedback response information in time domain.

In some embodiments, the uplink channel for carrying the HP SR partially or completely overlaps both the uplink channel for carrying the HP feedback response information and the uplink channel for carrying the LP feedback response information.

In some embodiments, partial overlapping may be understood as that the uplink channel for carrying the HP SR completely belongs to both the uplink channel for carrying the HP feedback response information and the uplink channel for carrying the LP feedback response information; or that the uplink channel for carrying the HP SR intersects with both the uplink channel for carrying the HP feedback response information and the uplink channel for carrying the LP feedback response information.

In some embodiments, FIG. 7C is a schematic diagram showing that the uplink channel for carrying the HP SR overlaps both the uplink channel for carrying the HP feedback response information and the uplink channel for carrying the LP feedback response information according to some embodiments of the present disclosure. In this case, the K=1 HP SR multiplexed by the terminal device includes only an HP SR4.

In some embodiments, FIG. 7D shows that the terminal device multiplexes K=4 HP SRs according to some embodiments of the present disclosure. The HP SRs include an HP SR1, HP SR2, HP SR3, and HP SR4. Referring to FIG. 7D, in this case, FIG. 7D includes a combination of the foregoing cases 1 to 3.

It should be noted that in some embodiments, the HP SR in the foregoing cases 1 to 3 includes a positive SR and a negative SR; or a positive SR. In some embodiments, K=2 HP SRs include a positive SR and a negative SR. In this case, the HP SR multiplexed by the terminal device includes only a positive SR.

In summary, considering that the multiplexed information includes SR information of different ranges, a plurality of composite cases of the HP SR, the HP feedback response information, and the LP feedback response information are further provided. In some embodiments, case 1 is an optimal solution.

FIG. 8 is a flowchart of a method for receiving UCI according to some embodiments of the present disclosure. Description is given in the embodiments based on an example in which the method is applied to a network device. The method includes the following processes.

In process 820, feedback response information of a first priority, feedback response information of a second priority, and an SR of the first priority are received over a first uplink channel resource. The first priority is higher than the second priority.

In some embodiments, the first uplink channel resource includes a first PUCCH resource.

In some embodiments, the feedback response information of the first priority includes an HP HARQ-ACK/NACK (HP A/N for short). The feedback response information of the second priority includes an LP HARQ-ACK/NACK (LP A/N for short). The SR of the first priority includes an HP SR.

In some embodiments, the first priority includes a priority index 1, which may also be referred to as an HP. In some embodiments, the second priority includes a priority index 0, which may also be referred to as an LP.

In some embodiments, the feedback response information of the first priority includes feedback response information of the first priority for dynamic scheduling (an HP dynamic A/N for short) and feedback response information of the first priority for SPS (an HP SPS A/N for short), which will be described in detail in the following embodiments.

In some embodiments, an uplink channel for carrying the feedback response information of the first priority, an uplink channel for carrying the feedback response information of the second priority, and an uplink channel for carrying the SR of the first priority overlap. In some embodiments, the uplink channel for carrying the feedback response information of the first priority, the uplink channel for carrying the feedback response information of the second priority, and the uplink channel for carrying the SR of the first priority overlap and satisfy a multiplexing timeline. In the case that the multiplexing timeline is satisfied, the terminal device multiplexes the uplink channel for carrying the feedback response information of the first priority, the uplink channel for carrying the feedback response information of the second priority, and the uplink channel for carrying the SR of the first priority.

In some embodiments, in the case that the multiplexing timeline is satisfied, the terminal device multiplexes the feedback response information of the first priority, the feedback response information of the second priority, and the SR of the first priority to obtain UCI. The terminal device transmits the UCI over the first uplink channel resource. In some embodiments, satisfying the multiplexing timeline means that a terminal has capabilities to process multiplexing between the three uplink channels prior to the first PUCCH resource.

In some embodiments, that the uplink channel for carrying the feedback response information of the first priority, the uplink channel for carrying the feedback response information of the second priority, and the uplink channel for carrying the SR of the first priority overlap includes: The uplink channel for carrying the feedback response information of the first priority, the uplink channel for carrying the feedback response information of the second priority, and the uplink channel for carrying the SR of the first priority overlap in time domain.

In some embodiments, that the uplink channel for carrying the feedback response information of the first priority, the uplink channel for carrying the feedback response information of the second priority, and the uplink channel for carrying the SR of the first priority overlap includes: the uplink channel for carrying the SR of the first priority partially or completely overlaps only the uplink channel for carrying the feedback response information of the first priority; the uplink channel for carrying the SR of the first priority partially or completely overlaps only the uplink channel for carrying the feedback response information of the second priority; and the uplink channel for carrying the SR of the first priority partially or completely overlaps the uplink channel for carrying the feedback response information of the first priority and the uplink channel for carrying the feedback response information of the second priority.

In some embodiments, for details of overlapping between a channel carrying the HP SR, a channel carrying the HP dynamic A/N, and a channel carrying the LP A/N, reference is made to the foregoing embodiments shown in FIGS. 7A to 7D.

In some embodiments, the first PUCCH resource is a PUCCH resource configured in a PUCCH configuration corresponding to the first priority. In other words, the first PUCCH resource is determined based on the PUCCH configuration corresponding to the first priority. In some embodiments, the PUCCH configuration corresponding to the first priority includes a second PUCCH configuration, and a PUCCH configuration corresponding to the second priority includes a first PUCCH configuration.

In summary, the feedback response information of the first priority, the feedback response information of the second priority, and the SR of the first priority are transmitted over the first PUCCH resource. The first priority is higher than the second priority. In this way, a technical problem of multiplexing an LP A/N, an HP A/N, and an HP SR on a same PUCCH for transmission is solved.

The following describes in detail two scenarios for the feedback response information of the first priority for dynamic scheduling (HP dynamic A/N for short) and the feedback response information of the first priority for SPS (HP SPS A/N for short).

Scenario for the HP dynamic A/N:

In some embodiments, the first uplink channel resource is a PUCCH resource in a PUCCH resource set. The PUCCH resource set belongs to the PUCCH configuration corresponding to the first priority. In other words, the PUCCH resource set is determined based on the PUCCH configuration corresponding to the first priority.

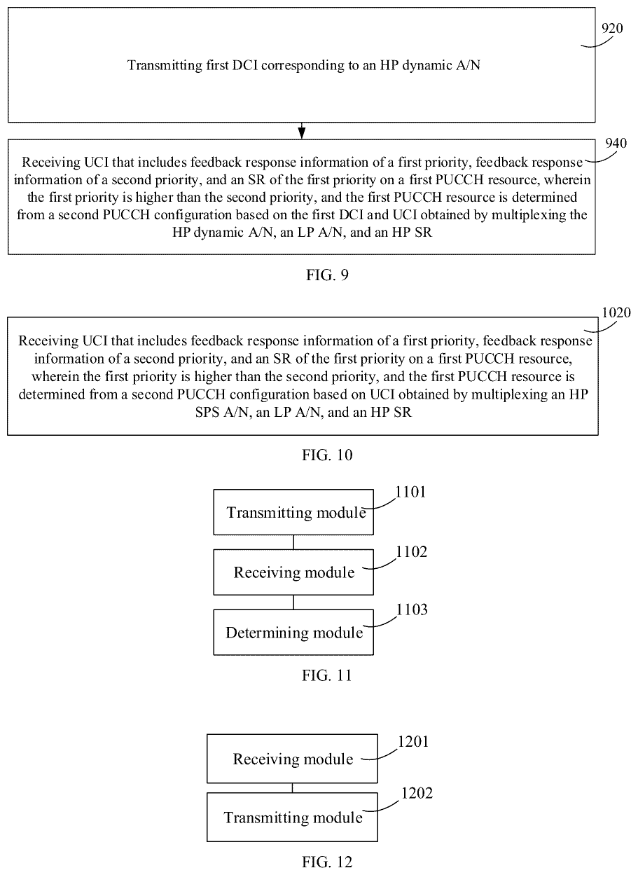

FIG. 9 is a flowchart of a method for receiving UCI according to some embodiments of the present disclosure. Description is given in the embodiments based on an example in which the method is applied to a network device. The method includes the following processes.

In process 920, first DCI corresponding to an HP dynamic A/N is transmitted.

In some embodiments, the first DCI is DCI corresponding to feedback response information of a first priority for dynamic scheduling. The network device transmits the first DCI to the terminal device.

In some embodiments, the HP dynamic A/N is HARQ-ACK information of a PDSCH for dynamic scheduling. That is, the HARQ-ACK information and/or the PDSCH are scheduled over the first DCI.

In some embodiments, the first DCI includes a PUCCH resource indicator field. In some embodiments, transmitting the first DCI corresponding to the HP dynamic A/N may be replaced by transmitting a PUCCH resource indicator field corresponding to the HP dynamic A/N.

In process 940, UCI that includes the feedback response information of the first priority, feedback response information of a second priority, and an SR of the first priority is received on a first PUCCH resource. The first priority is higher than the second priority. The first PUCCH resource is determined from a second PUCCH configuration based on the first DCI and the UCI that includes the HP dynamic A/N, an LP A/N, and an HP SR.

In some embodiments, determining the first PUCCH resource includes: based on a total number of bits of the UCI that includes the HP dynamic A/N, the LP A/N, and the HP SR, determining, by the terminal device, to use a PUCCH resource set in the second PUCCH configuration.

In some embodiments, the terminal device determines a PUCCH resource in the PUCCH resource set based on the PUCCH resource indicator field included in the first DCI.

In some embodiments, the terminal device adds K HP SRs to the HP dynamic A/N to form HP UCI. In some embodiments, adding may be understood as adding the HP SRs before or after the HP dynamic A/N.

In some embodiments, in the case that the number of HP SRs is K, the HP SRs are added to the HP dynamic A/N to form HP UCI with O_{UCI-HP} bits.

In some embodiments, O_{UCI-HP}=O_{HP-ACK}+[log₂(K+1)]. O_{UCI-HP} represents the number of bits of the HP UCI. O_{HP-ACK} represents the number of bits of the HP dynamic A/N. [log₂(K+1)] is used to calculate the number of bits of the K HP SRs. K is a positive integer. log₂(K+1) is used to calculate a logarithm of (K+1) to the base 2. ┌ ┐ represents rounding up log₂(K+1).

In some embodiments, an uplink channel for carrying the HP dynamic A/N, an uplink channel for carrying the LP A/N, and an uplink channel for carrying the HP SR overlap. In some embodiments, the uplink channel for carrying the HP dynamic A/N, the uplink channel for carrying the LP A/N, and the uplink channel for carrying the HP SR overlap and satisfy a multiplexing timeline. In the case that the multiplexing timeline is satisfied, the terminal device multiplexes the uplink channel for carrying the HP dynamic A/N, the uplink channel for carrying the LP A/N, and the uplink channel for carrying the HP SR. In some embodiments, satisfying the multiplexing timeline means that a terminal has capabilities to process multiplexing between the three uplink channels prior to the first PUCCH resource.

In some embodiments, FIG. 4 is a schematic diagram showing that the terminal determines a first PUCCH carrying the HP dynamic A/N, the LP A/N, and the HP SR. FIG. 4 shows that the channel carrying the HP SR, the channel carrying the HP dynamic A/N, and the channel carrying the LP A/N overlap. The terminal device multiplexes the HP SR, the HP dynamic A/N, and the LP A/N on the first PUCCH 401 for transmission.

In some embodiments, for details of overlapping between the channel carrying the HP SR, the channel carrying the HP dynamic A/N, and the channel carrying the LP A/N, reference is made to the foregoing embodiments shown in FIGS. 7A to 7D.

In summary, in the case that the LP A/N, the HP A/N, and the HP SR are multiplexed and transmitted over the same PUCCH, multiplexed information is transmitted over a resource of the HP dynamic A/N, which ensures low latency and high reliability of HP information. In the case that a resource of the HP SR is used for transmission, according to the description of the related art, the HP SR carries up to 2 bits and fails to carry three types of UCI. In the case that a resource of the LP A/N is used for transmission, a code rate, a symbol length, and the like of an LP PUCCH may not meet latency and reliability requirements of the HP A/N.

Scenario for the HP SPS A/N:

In some embodiments, the first uplink channel resource is a PUCCH resource in a PUCCH feedback resource list corresponding to SPS. In some embodiments, the PUCCH feedback resource list belongs to the PUCCH configuration corresponding to the first priority.

In some embodiments, the first uplink channel resource is determined based on a first total number of bits and PUCCH resources in the PUCCH feedback resource list corresponding to SPS. In some embodiments, the first total number of bits is a sum of the number of bits of the feedback response information of the first priority, the number of bits of the feedback response information of the second priority, and the number of bits of the SR of the first priority.

FIG. 10 is a flowchart of a method for receiving UCI according to some embodiments of the present disclosure. Description is given in the embodiments based on an example in which the method is applied to a network device. The method includes the following processes.

In process 1020, UCI that includes feedback response information of a first priority, feedback response information of a second priority, and an SR of the first priority is received over a first PUCCH resource. The first priority is higher than the second priority. The first PUCCH resource is determined from a second PUCCH configuration based on UCI obtained by multiplexing an HP SPS A/N, an LP A/N, and an HP SR.

In some embodiments, determining the first PUCCH resource includes: based on a total number of bits of the UCI that includes the HP SPS A/N, the LP A/N, and the HP SR, determining, by the terminal device, to use a PUCCH resource corresponding to the total number of bits in a PUCCH feedback resource list corresponding to an SPS PDSCH in the second PUCCH configuration as the first PUCCH resource.

In some embodiments, based on a total number of bits of the UCI that includes the HP SPS A/N, the LP A/N, and the HP SR, the terminal device determines to use a PUCCH resource within a range corresponding to the total number of bits in a PUCCH feedback resource list in the second PUCCH configuration as the first PUCCH resource.

In some embodiments, based on a total number of bits of the UCI that includes the HP SPS A/N, the LP A/N, and the HP SR, the terminal device determines to use one of a plurality of PUCCH resources within a range corresponding to the total number of bits in a PUCCH feedback resource list in the second PUCCH configuration as the first PUCCH resource.

In some embodiments, the PUCCH feedback resource list corresponding to the SPS PDSCH includes SPS-PUCCH-AN-List and/or n1PUCCH-AN.

In some embodiments, the terminal device adds K HP SRs to the HP SPS A/N to form HP UCI.

In some embodiments, in the case that the number of HP SRs is K, the HP SRs are added to the HP SPS A/N to form HP UCI with O_{UCI-HP} bits.

In some embodiments, O_{UCI-HP}=O_{HP-ACK}+[log₂(K+1)]. O_{UCI-HP} represents the number of bits of the HP UCI. O_{HP-ACK} represents the number of bits of the HP SPS A/N. [log₂(K+1)] represents the number of bits of the K HP SRs. K is a positive integer. log₂(K+1) is used to calculate a logarithm of (K+1) to the base 2. ┌ ┐ represents rounding up log₂(K+1).

In some embodiments, the SPS A/N includes HARQ-ACK feedback information for the SPS PDSCH. In some embodiments, the SPS PDSCH includes a PDSCH without corresponding PDCCH/DCI.

In some embodiments, an uplink channel for carrying the HP SPS A/N, an uplink channel for carrying the LP A/N, and an uplink channel for carrying the HP SR overlap. In some embodiments, the uplink channel for carrying the HP SPS A/N, the uplink channel for carrying the LP A/N, and the uplink channel for carrying the HP SR overlap and satisfy a multiplexing timeline. In the case that the multiplexing timeline is satisfied, the terminal device multiplexes the uplink channel for carrying the HP SPS A/N, the uplink channel for carrying the LP A/N, and the uplink channel for carrying the HP SR. In some embodiments, satisfying the multiplexing timeline means that a terminal has capabilities to process multiplexing between the three uplink channels prior to the first PUCCH resource.

In some embodiments, FIG. 6 is a schematic diagram showing that the terminal device determines a first PUCCH carrying the HP SPS A/N, the LP A/N, and the HP SR. FIG. 6 shows that the channel carrying the HP SR, the channel carrying the HP SPS A/N, and the uplink channel carrying the LP A/N overlap. The terminal device multiplexes the HP SR, the HP SPS A/N, and the LP A/N on the first PUCCH 601 for transmission.

In some embodiments, the number of SRs of the first priority is K. K is a positive integer. The K SRs of the first priority include a target SR.

In some embodiments, an uplink channel for carrying the target SR overlaps the uplink channel for carrying the HP A/N.

In some embodiments, an uplink channel for carrying the target SR overlaps the uplink channel for carrying the LP A/N.

In some embodiments, an uplink channel for carrying the target SR overlaps both the uplink channel for carrying the feedback response information of the first priority and the uplink channel for carrying the feedback response information of the second priority.

In some embodiments, for details of overlapping between the channel carrying the target SR, the channel carrying the HP dynamic A/N, and the channel carrying the LP A/N, reference is made to the embodiments shown in FIGS. 7A to 7D.

In summary, in the case that the LP A/N, the HP A/N, and the HP SR are multiplexed and transmitted over the same PUCCH, multiplexed information is transmitted over a resource of the HP SPS A/N, which ensures low latency and high reliability of HP information. In the case that a resource of the HP SR is used for transmission, according to the description of the related art, the HP SR carries up to 2 bits and fails to carry three types of UCI. In the case that a resource of the LP A/N is used for transmission, a code rate, a symbol length, and the like of an LP PUCCH may not meet latency and reliability requirements of the HP A/N.

In some embodiments, the terminal device does not expect a first total number of bits to be greater than a maximum number of bits carried by the PUCCH feedback resource list for SPS. The first total number of bits is a sum of the number of bits of the feedback response information of the first priority, the number of bits of the feedback response information of the second priority, and the number of bits of the SR of the first priority.

It should be noted that the process that the terminal device does not expect the first total number of bits to be greater than the maximum number of bits carried by the PUCCH feedback resource list for SPS includes: in the case that the feedback response information of the first priority, the feedback response information of the second priority, and the SR of the first priority are transmitted over the first PUCCH resource, not expecting, by the terminal device, the first total number of bits to be greater than the maximum number of bits carried by the PUCCH feedback resource list for SPS; and in the case that the feedback response information of the first priority, the feedback response information of the second priority, and the SR of the first priority are not transmitted over the first PUCCH resource, not expecting, by the terminal device, the first total number of bits to be greater than the maximum number of bits carried by the PUCCH feedback resource list for SPS.

In some embodiments, a network device estimates a second total number of bits. The second total number of bits is the sum of the number of bits of the feedback response information of the first priority, the number of bits of the feedback response information of the second priority, and the number of bits of the SR of the first priority. The network device configures the maximum number of bits carried by the PUCCH feedback resource list for SPS to be greater than the second total number of bits.

It should be noted that the process that the network device configures the maximum number of bits carried by the PUCCH feedback resource list for SPS to be greater than the second total number of bits includes: in the case that the feedback response information of the first priority, the feedback response information of the second priority, and the SR of the first priority are transmitted over the first PUCCH resource, configuring, by the network device, the maximum number of bits carried by the PUCCH feedback resource list for SPS to be greater than the second total number of bits; and in the case that the feedback response information of the first priority, the feedback response information of the second priority, and the SR of the first priority are not transmitted over the first PUCCH resource, configuring, by the network device, the maximum number of bits carried by the PUCCH feedback resource list for SPS to be greater than the second total number of bits.

In some embodiments, the process that the network device receives the feedback response information of the first priority, the feedback response information of the second priority, and the SR of the first priority on the first PUCCH resource further includes: transmitting, by the network device, a PUCCH configuration to the terminal device.

In some embodiments, the process that the network device transmits the PUCCH configuration to the terminal device includes: transmitting, by the network device, a first PUCCH configuration and a second PUCCH configuration to the terminal device. The first PUCCH configuration corresponds to the LP A/N. That is, a priority index corresponding to the first PUCCH configuration is 0. The second PUCCH configuration corresponds to the HP A/N. That is, a priority index corresponding to the second PUCCH configuration is 1. In some embodiments, an uplink channel for feedback response information is configured based on the PUCCH configuration. In some embodiments, a PUCCH corresponding to the HP A/N is configured based on the first PUCCH configuration, and a PUCCH corresponding to the LP A/N is configured based on the second PUCCH configuration.

FIG. 11 is a structural block diagram of an apparatus for transmitting UCI according to some embodiments of the present disclosure.

The apparatus includes: a transmitting module 1101, configured to transmit feedback response information of a first priority, feedback response information of a second priority, and an SR of the first priority over a first uplink channel resource, wherein the first priority is higher than the second priority.

In some embodiments, the apparatus further includes a receiving module 1102. The receiving module 1102 is configured to receive first DCI corresponding to an HP dynamic A/N.

In some embodiments, the receiving module 1102 is further configured to receive a PUCCH configuration from a network device.

In some embodiments, the receiving module 1102 is further configured to receive a first PUCCH configuration and a second PUCCH configuration from the network device.

In some embodiments, the apparatus further includes a determining module 1103. The determining module 1103 is configured to determine a PUCCH on which the feedback response information of the first priority, the feedback response information of the second priority, and the SR of the first priority are multiplexed and transmitted.

In some embodiments, an uplink channel for carrying the feedback response information of the first priority, an uplink channel for carrying the feedback response information of the second priority, and an uplink channel for carrying the SR of the first priority overlap.

In some embodiments, the first uplink channel resource is a PUCCH resource configured in a PUCCH configuration corresponding to the first priority.

In some embodiments, the feedback response information of the first priority includes feedback response information for dynamic scheduling.

In some embodiments, the first uplink channel resource is a PUCCH resource in a PUCCH resource set. The PUCCH resource set belongs to the PUCCH configuration corresponding to the first priority.

In some embodiments, the first uplink channel resource is determined from the PUCCH resource set based on a PUCCH resource indicator field in the first DCI, wherein the first DCI corresponds to the feedback response information of the first priority.

In some embodiments, the feedback response information of the first priority includes feedback response information for SPS.

In some embodiments, the first uplink channel resource is a PUCCH resource in a PUCCH feedback resource list corresponding to SPS, wherein the PUCCH feedback resource list belongs to the PUCCH configuration corresponding to the first priority.

In some embodiments, the first uplink channel resource is determined based on a first total number of bits and PUCCH resources in the PUCCH feedback resource list corresponding to SPS. The first total number of bits is a sum of the number of bits of the feedback response information of the first priority, the number of bits of the feedback response information of the second priority, and the number of bits of the SR of the first priority.

In some embodiments, the terminal does not expect a first total number of bits to be greater than a maximum number of bits carried by the PUCCH feedback resource list for SPS. The first total number of bits is a sum of the number of bits of the feedback response information of the first priority, the number of bits of the feedback response information of the second priority, and the number of bits of the SR of the first priority.

In some embodiments, the number of SRs of the first priority is K. The K SRs of the first priority include a target SR. An uplink channel for carrying the target SR overlaps the uplink channel for carrying the feedback response information of the first priority.

In some embodiments, the uplink channel for carrying the feedback response information of the first priority includes an uplink channel for the feedback response information of the first priority on which UCI of the first priority is not multiplexed, and/or an uplink channel on which the feedback response information of the first priority and the SR of the first priority are multiplexed.

In some embodiments, the number of SRs of the first priority is K. The K SRs of the first priority include a target SR. An uplink channel for carrying the target SR overlaps the uplink channel for carrying the feedback response information of the second priority.

In some embodiments, the uplink channel for carrying the feedback response information of the second priority includes an uplink channel for the feedback response information of the second priority on which UCI of the second priority is not multiplexed, and/or an uplink channel on which the feedback response information of the second priority and another uplink channel of the second priority are multiplexed.

In some embodiments, the number of SRs of the first priority is K. The K SRs of the first priority include a target SR. An uplink channel for carrying the target SR overlaps both the uplink channel for carrying the feedback response information of the first priority and the uplink channel for carrying the feedback response information of the second priority.

In some embodiments, the SR of the first priority includes a positive SR and a negative SR; or a positive SR.

In some embodiments, the number of bits of the UCI of the first priority carried on the first uplink channel resource is equal to a sum of the number of bits of the feedback response information of the first priority and the number of bits of the SR of the first priority.

In some embodiments, O_{UCI-HP}=O_{HP-ACK}+[log₂(K+1)]. O_{UCI-HP} represents the number of bits of the UCI of the first priority. O_{HP-ACK} represents the number of bits of the feedback response information of the first priority. [log₂(K+1)] represents the number of bits of the K SRs of the first priority.

The number of SRs of the first priority is K. The SRs of the first priority and the feedback response information of the first priority are multiplexed to form the UCI of the first priority and O_{UCI-HP}=O_{HP-ACK}+[log₂(K+1)] bits.

O_{HP-ACK} represents the number of bits of the feedback response information of the first priority. [log₂(K+1)] represents the number of bits of the K SRs of the first priority.

In summary, the feedback response information of the first priority, the feedback response information of the second priority, and the SR of the first priority are transmitted over the first uplink channel resource. The first priority is higher than the second priority. In this way, a technical problem of multiplexing an LP A/N, an HP A/N, and an HP SR on a same PUCCH for transmission is solved.

FIG. 12 is a structural block diagram of an apparatus for receiving UCI according to some embodiments of the present disclosure.

The apparatus includes: a receiving module 1201, configured to receive feedback response information of a first priority, feedback response information of a second priority, and an SR of the first priority over a first uplink channel resource, wherein the first priority is higher than the second priority.

In some embodiments, the apparatus further includes a transmitting module 1202. The transmitting module 1202 is configured to transmit first DCI corresponding to an HP dynamic A/N.

In some embodiments, the transmitting module 1202 is further configured to transmit a PUCCH configuration.

In some embodiments, the transmitting module 1202 is further configured to transmit a first PUCCH configuration and a second PUCCH configuration.

In some embodiments, an uplink channel for carrying the feedback response information of the first priority, an uplink channel for carrying the feedback response information of the second priority, and an uplink channel for carrying the SR of the first priority overlap.

In some embodiments, the first uplink channel resource is a PUCCH resource configured in a PUCCH configuration corresponding to the first priority.

In some embodiments, the feedback response information of the first priority includes feedback response information for dynamic scheduling.

In some embodiments, the first uplink channel resource is a PUCCH resource in a PUCCH resource set, wherein the PUCCH resource set belongs to the PUCCH configuration corresponding to the first priority.

In some embodiments, the first uplink channel resource is determined from the PUCCH resource set based on a PUCCH resource indicator field in the first DCI, wherein the first DCI corresponds to the feedback response information of the first priority.

In some embodiments, the feedback response information of the first priority includes feedback response information for SPS.

In some embodiments, the first uplink channel resource is a PUCCH resource in a PUCCH feedback resource list corresponding to SPS, wherein the PUCCH feedback resource list belongs to the PUCCH configuration corresponding to the first priority.

In some embodiments, the first uplink channel resource is determined based on a first total number of bits and PUCCH resources in the PUCCH feedback resource list corresponding to SPS. The first total number of bits is a sum of the number of bits of the feedback response information of the first priority, the number of bits of the feedback response information of the second priority, and the number of bits of the SR of the first priority.

In some embodiments, the terminal does not expect a first total number of bits to be greater than a maximum number of bits carried by the PUCCH feedback resource list for SPS. The first total number of bits is a sum of the number of bits of the feedback response information of the first priority, the number of bits of the feedback response information of the second priority, and the number of bits of the SR of the first priority.

In some embodiments, the number of SRs of the first priority is K. The K SRs of the first priority include a target SR. An uplink channel for carrying the target SR overlaps the uplink channel for carrying the feedback response information of the first priority.

In some embodiments, the uplink channel for carrying the feedback response information of the first priority includes an uplink channel for the feedback response information of the first priority on which UCI of the first priority is not multiplexed, and/or an uplink channel on which the feedback response information of the first priority and the SR of the first priority are multiplexed.

In some embodiments, the number of SRs of the first priority is K. The K SRs of the first priority include a target SR. An uplink channel for carrying the target SR overlaps the uplink channel for carrying the feedback response information of the second priority.

In some embodiments, the uplink channel for carrying the feedback response information of the second priority includes an uplink channel for the feedback response information of the second priority on which UCI of the second priority is not multiplexed, and/or an uplink channel on which the feedback response information of the second priority and another uplink channel of the second priority are multiplexed.

In some embodiments, the SR of the first priority includes a positive SR and a negative SR; or a positive SR.

In some embodiments, the number of SRs of the first priority is K. The K SRs of the first priority include a target SR. An uplink channel for carrying the target SR overlaps both the uplink channel for carrying the feedback response information of the first priority and the uplink channel for carrying the feedback response information of the second priority.

In some embodiments, the number of bits of the UCI of the first priority carried on the first uplink channel resource is equal to a sum of the number of bits of the feedback response information of the first priority and the number of bits of the SR of the first priority.

In some embodiments, O_{UCI-HP}=O_{HP-ACK}+[log₂(K+1)]. O_{UCI-HP} represents the number of bits of the UCI of the first priority. O_{HP-ACK} represents the number of bits of the feedback response information of the first priority. [log₂(K+1)] represents the number of bits of the K SRs of the first priority. In summary, the feedback response information of the first priority, the feedback response information of the second priority, and the SR of the first priority are transmitted over the first uplink channel resource. The first priority is higher than the second priority. In this way, a technical problem of multiplexing an LP A/N, an HP A/N, and an HP SR on a same PUCCH for transmission is solved.

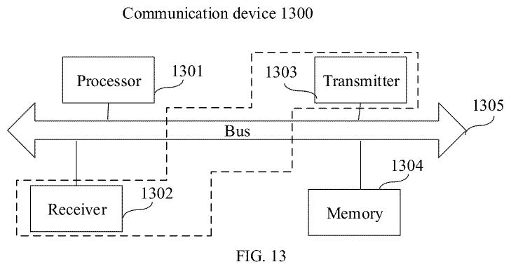

FIG. 13 is a schematic structural diagram of a communication device (UE or a network device) according to some embodiments of the present disclosure. The communication device includes a processor 1301, a receiver 1302, a transmitter 1303, a memory 1304, and a bus 1305.

The processor 1301 includes one or more processing cores. The processor 1301 runs various functional applications and performs information processing by running software programs and modules.

The receiver 1302 and the transmitter 1303 may be practiced as a communication component, which may be a communication chip.

The memory 1304 is connected to the processor 1301 over the bus 1305.

The memory 1304 is configured to store at least one instruction. The processor 1301 is configured to execute the at least one instruction to perform the processes of the foregoing method embodiments.

In addition, the memory 1304 may be implemented by any type of volatile or non-volatile storage device or a combination thereof. The volatile or non-volatile storage device includes but is not limited to: a magnetic disk or an optical disc, an electrically erasable programmable read-only memory (EEPROM), an erasable programmable read-only memory (EPROM), a static random-access memory (SRAM), a read-only memory (ROM), a magnetic memory, a flash memory, or a programmable ROM (PROM).

Some embodiments further provide a non-transitory computer-readable storage medium including one or more instructions, for example, a memory including one or more instructions. The instructions, when executed by a processor of a communication device, cause the communication device to perform the method for transmitting UCI. For example, the non-transitory computer-readable storage medium may be a ROM, a random-access memory (RAM), a compact disc ROM (CD-ROM), a magnetic tape, a floppy disk, an optical data storage device, or the like.

The one or more instructions in the non-transitory computer-readable storage medium, when loaded and executed by the processor of the communications device, cause the communication device to perform the method for transmitting UCI.

Some embodiments of the present disclosure further provide a network device. The network device includes a processor and a transceiver connected to the processor. The processor is configured to load and execute one or more executable instructions to perform the method for transmitting UCI according to the above method embodiments.

Some embodiments of the present disclosure further provide a chip. The chip includes programmable logic circuitry and/or one or more program instructions. The chip, when running, is caused to perform the method for transmitting UCI according to the above method embodiments.

Some embodiments of the present disclosure further provide a non-transitory computer-readable storage medium. The computer-readable storage medium stores at least one instruction, at least one program, a code set, or an instruction set. The at least one instruction, the at least one program, the code set, or the instruction set, when loaded and executed by a processor, causes the processor to perform the method for transmitting UCI according to the above method embodiments.

It should be understood that the mentioned term “a plurality of” in this specification means two or more. The term “and/or” describes the association relationship between associated objects, and it indicates three types of relationships. For example, “A and/or B” may indicate that A exists alone, A and B coexist, or B exists alone. The symbol “/” usually indicates an “or” relationship between associated objects.

Those skilled in the art may easily figure out other implementations of the present disclosure after considering the specification and practicing the present disclosure. The present disclosure is intended to cover any variations, purposes, or adaptive changes of the present disclosure. Such variations, purposes, or adaptive changes follow the general principle of the present disclosure and include common knowledge or conventional technical means in the technical field which is not disclosed in the present disclosure. The specification and embodiments are merely considered as illustrative, and the real scope and spirit of the present disclosure are pointed out by the appended claims.

It should be understood that the present disclosure is not limited to the precise structures that have been described above and shown in the accompanying drawings, and may be modified and changed in many ways without departing from the scope of the present disclosure. The scope of the present disclosure is defined by the appended claims.

1. A method for transmitting uplink control information (UCI), comprising:
transmitting feedback response information of a first priority, feedback response information of a second priority, and one or more scheduling requests (SRs) of the first priority over a first uplink channel resource, wherein the first priority is higher than the second priority.

2. The method according to claim 1, wherein an uplink channel for carrying the feedback response information of the first priority, an uplink channel for carrying the feedback response information of the second priority, and an uplink channel for carrying the SR of the first priority overlap.

3. The method according to claim 1, wherein the first uplink channel resource is a physical uplink control channel (PUCCH) resource configured in a PUCCH configuration corresponding to the first priority.

4. The method according to claim 1, wherein the feedback response information of the first priority comprises:
feedback response information for dynamic scheduling.

5. The method according to claim 4, wherein the first uplink channel resource is a PUCCH resource in a PUCCH resource set, the PUCCH resource set belonging to a PUCCH configuration corresponding to the first priority.

6. The method according to claim 5, wherein the first uplink channel resource is determined from the PUCCH resource set based on a PUCCH resource indicator field in first downlink control information (DCI), the first DCI corresponding to the feedback response information of the first priority.

7. The method according to claim 1, wherein the feedback response information of the first priority comprises:
feedback response information for semi-persistent scheduling (SPS).

8. The method according to claim 7, wherein the first uplink channel resource is a PUCCH resource in a PUCCH feedback resource list corresponding to SPS, the PUCCH feedback resource list belonging to a PUCCH configuration corresponding to the first priority.

9. The method according to claim 8, wherein the first uplink channel resource is determined based on a first total number of bits and PUCCH resources in the PUCCH feedback resource list corresponding to SPS, the first total number of bits being a sum of a number of bits of the feedback response information of the first priority, a number of bits of the feedback response information of the second priority, and a number of bits of the SR of the first priority.

10. The method according to claim 1, wherein a number of the SRs of the first priority is K, K being a positive integer, wherein the K SRs of the first priority comprise a target SR; and
an uplink channel for carrying the target SR overlaps the uplink channel for carrying the feedback response information of the first priority,
wherein the uplink channel for carrying the feedback response information of the first priority comprises:
an uplink channel for the feedback response information of the first priority on which UCI of the first priority is not multiplexed; and/or
an uplink channel on which the feedback response information of the first priority and the SR of the first priority are multiplexed.

11. A terminal device, comprising:
a processor and a memory storing one or more computer programs, wherein the one or more computer programs when executed by the processor, cause the terminal device to:
transmit feedback response information of a first priority, feedback response information of a second priority, and one or more scheduling requests (SRs) of the first priority over a first uplink channel resource, wherein the first priority is higher than the second priority.

12. The terminal device according to claim 11, wherein an uplink channel for carrying the feedback response information of the first priority, an uplink channel for carrying the feedback response information of the second priority, and an uplink channel for carrying the SR of the first priority overlap.

13. The terminal device according to claim 11, wherein the first uplink channel resource is a physical uplink control channel (PUCCH) resource configured in a PUCCH configuration corresponding to the first priority.

14. A network device, comprising:
a processor and a memory storing one or more computer programs therein, wherein the one or more computer programs when executed by the processor, cause the network device to:
receive feedback response information of a first priority, feedback response information of a second priority, and one or more scheduling requests (SRs) of the first priority over a first uplink channel resource, wherein the first priority is higher than the second priority.

15. The network device according to claim 14, wherein an uplink channel for carrying the feedback response information of the first priority, an uplink channel for carrying the feedback response information of the second priority, and an uplink channel for carrying the SR of the first priority overlap.

16. The network device according to claim 14, wherein the first uplink channel resource is a physical uplink control channel (PUCCH) resource configured in a PUCCH configuration corresponding to the first priority.

17. The network device according to claim 14, wherein the feedback response information of the first priority comprises:
feedback response information for dynamic scheduling,
wherein the first uplink channel resource is a PUCCH resource in a PUCCH resource set, the PUCCH resource set belonging to a PUCCH configuration corresponding to the first priority,
wherein the first uplink channel resource is determined from the PUCCH resource set based on a PUCCH resource indicator field in first downlink control information (DCI), the first DCI corresponding to the feedback response information of the first priority.

18. The network device according to claim 14, wherein the feedback response information of the first priority comprises:
feedback response information for semi-persistent scheduling (SPS),
wherein the first uplink channel resource is a PUCCH resource in a PUCCH feedback resource list corresponding to SPS, the PUCCH feedback resource list belonging to a PUCCH configuration corresponding to the first priority,
wherein the first uplink channel resource is determined based on a first total number of bits and PUCCH resources in the PUCCH feedback resource list corresponding to SPS, the first total number of bits being a sum of a number of bits of the feedback response information of the first priority, a number of bits of the feedback response information of the second priority, and a number of bits of the SR of the first priority.

19. The network device according to claim 14, wherein a number of the SRs of the first priority is K, K being a positive integer, wherein the K SRs of the first priority comprise a target SR; and
an uplink channel for carrying the target SR overlaps the uplink channel for carrying the feedback response information of the first priority,
wherein the uplink channel for carrying the feedback response information of the first priority comprises:
an uplink channel for the feedback response information of the first priority on which UCI of the first priority is not multiplexed; and/or
an uplink channel on which the feedback response information of the first priority and the SR of the first priority are multiplexed.

20. The network device according to claim 14, wherein number of bits of UCI of the first priority carried on the first uplink channel resource is equal to a sum of the number of bits of the feedback response information of the first priority and the number of bits of the SR of the first priority,
wherein a number of SRs of the first priority is K, K being a positive integer; and
$${O}_{UCI - HP} = {O}_{HP - ACK} + ⌈ {log}_{2} ( K + 1 ) ⌉ ;$$
wherein O_{UCI-HP} represents the number of bits of the UCI of the first priority, O_{HP-ACK} represents the number of bits of the feedback response information of the first priority, and [log₂(K+1)] represents a number of bits of the K SRs of the first priority.
